(19) United States
(12) Patent Application Publication
(10) Pub. No.: US 2017/0145903 A1
(43) Pub. Date: May 25, 2017

(54) CONTROL SYSTEM FOR INTERNAL COMBUSTION ENGINE

(71) Applicant: TOYOTA JIDOSHA KABUSHIKI KAISHA, Toyota-shi, Aichi-ken (JP)

(72) Inventor: Shinji SADAKANE, Susono-shi (JP)

(73) Assignee: TOYOTA JIDOSHA KABUSHIKI KAISHA, Toyota-shi, Aichi-ken (JP)

(21) Appl. No.: 15/309,703

(22) PCT Filed: Jun. 3, 2015
(86) PCT No.: PCT/JP2015/002814

§ 371 Date: Nov. 8, 2016

(30) Foreign Application Priority Data
Jun. 20, 2014 (JP) 2014-127174

(51) Int. Cl. F02B 29/04; G01M 15/05; F02M 26/09

(52) U.S. Cl. CPC F02B 29/0493; F02M 26/09; G01M 15/05

(57) ABSTRACT

An object is to acquire a humidity of gas compressed by a compressor accurately, in a control system for an internal combustion engine that executes control concerning a water content in intake gas passing through an intercooler, based on an output signal from a humidity sensor. A humidity sensor is provided in an intake passage between a compressor and an intercooler. Therefore, a behavior of a humidity of gas that is compressed by the compressor and flows in the intake passage at an upstream side from the intercooler can be accurately grasped. The humidity sensor is desirably provided in the intake passage directly downstream from the compressor.

### TECHNICAL FIELD

The present invention relates to a control system for an internal combustion engine, and more particularly relates to a control system for an internal combustion engine including a low pressure EGR device.

### BACKGROUND ART

Conventionally, there has been known an internal combustion engine including an EGR device that recirculate: a part of exhaust gas flowing in an exhaust passage at a downstream side from a turbine to an intake passage at an upstream side from a compressor. An EGR device like this is distinguished from an EGR device that re-circulates a part of exhaust gas flowing in an exhaust passage at an upstream side from a turbine to an intake passage at a downstream side from a compressor, and is called a low pressure EGR device.

As the internal combustion engine including a low pressure EGR device, the control system for an internal combustion engine disclosed in Japanese Patent Laid-Open No. 2010-223179 is cited, for example. In order to restrain condensed water from being generated from intake gas (hereinafter, called “a mixture gas”) obtained after EGR gas and fresh air join each other, the control system controls the rotational speed of the refrigerant pump of a water-cooling type EGR cooler, and performs dehumidification of the EGR gas which passes through the EGR cooler. On the occasion of control of the refrigerant pump, a water vapor amount Gaw contained in the fresh air before joining the EGR gas is calculated based on an output signal from an air flow meter, and an output signal from a humidity sensor that is provided in the vicinity of the air flow meter.

### CITATION LIST

### Patent Literature

### PTL 1: Japanese Patent Laid-Open No. 2010-223179

### SUMMARY OF INVENTION

### Technical Problem

Incidentally, when a movable body such as a vehicle loaded with the, above described internal combustion engine travels in a district where a fog sets in, fresh air with a humidity of substantially 100% containing mist passes through the air flow meter to flow into the compressor. Further, when the compressor is driven, the gas flowing into the compressor is compressed to raise partial pressure of the water vapor contained in the compressed gas, and a temperature of the compressed gas also rises, whereby saturated water vapor pressure rises.

Here, if the partial pressure of the water vapor contained in the compressed gas is equal to or higher than the saturated water vapor pressure of the compressed gas, the humidity of the compressed gas is kept at 100%. However, if the partial pressure of the water vapor contained in the compressed gas becomes lower than the saturated water vapor pressure of the compressed gas, the humidity of the compressed gas becomes lower than 100%. Accordingly, if the compressor of the above described movable body is driven during traveling in the district where a fog sets in, when the partial pressure of the water vapor contained in the gas after being compressed by the compressor becomes lower than the saturated water vapor pressure, the humidity of the compressed gas becomes lower than 100%.

When the humidity of the compressed gas becomes lower than 100%, the mist around the compressed gas can be evaporated. When the mist around the compressed gas is evaporated, the amount of water vapor contained in the compressed gas increases. When the amount of the water vapor contained in the compressed gas increases, the humidity of the compressed gas which is reduced by compression by the compressor increases again, and therefore, it becomes difficult to grasp the humidity of the compressed gas. Further, when the amount of the water vapor contained in the compressed gas increased, the condensed water is readily generated from the compressed gas at the time of passing through the intercooler, and becomes a cause of corrosion of the intercooler.

In this regard, the above described control system measures the humidity of the fresh air before mixing with the EGR gas, by the humidity sensor provided in the vicinity of the air flow meter. Therefore, the humidity of the gas which is compressed by the compressor cannot be grasped, and the occurrence of the aforementioned trouble cannot be avoided.

The present invention is made address the problem as described above. That is to say, the present invention has an object to acquire a humidity of gas that is compressed by a compressor accurately, in a control system for an internal combustion engine that executes control concerning a water content in an intake gas that passes through an intercooler based on an output signal of a humidity sensor.

### Solution to Problem

A first aspect of the present invention is a control system for an internal combustion engine including a compressor that compresses intake gas flowing in an intake passage of an internal combustion engine, an intercooler that cools the intake gas compressed by the compressor, and a humidity sensor that measures a humidity of the intake gas flowing in the intake passage, and executing control concerning a water content in the intake gas passing through the intercooler at a time of driving the compressor, based on an output signal from the humidity sensor,

wherein the humidity sensor is provided in the intake passage between the compressor and the intercooler.

A second aspect of the present invention is the control system according e first aspect,

wherein the humidity sensor is provided directly downstream of the compressor.

A third aspect of the present invention is the control system according to the first or second aspect,

wherein the control is control that restrains an amount of condensed water generated in the intercooler to be equal to or smaller than an allowable amount.

A fourth aspect of the present invention is the control system according to any one Of the first to third aspects, further including:

an EGR device that recirculates a part of exhaust gas flowing in an exhaust passage at a downstream side from a turbine connected to the compressor to the intake passage at an upstream side from the compressor.

### Advantageous Effect of Invention

According to the present invention, the humidity of the gas compressed by the compressor can be accurately acquired in the control system for an internal combustion engine that executes control concerning the water content in the intake gas which passes through the intercooler based on the output signal from the humidity sensor.

### BRIEF DESCRIPTION OF DRAWINGS

FIG. 1 is a diagram for explaining a configuration of a control system for an internal combustion engine of Embodiment 1 of the present invention.

FIG. 2 is a diagram showing behaviors of pressures, temperatures, dew point temperatures and relative humidities of two kinds of air flowing in the intake passage during a supercharging operation of the internal combustion engine.

FIG. 3 is a flowchart showing a routine of the I/C temperature regulation control executed by an ECU.

FIG. 4 is a flowchart showing a routine of the EGR rate control executed by the ECU.

FIG. 5 is a diagram for explaining a configuration of a control system for an internal combustion engine of Embodiment 3 of the present invention.

FIG. 6 is a flowchart showing a routine of the EGR gas temperature control executed by the ECU.

### DESCRIPTION OF EMBODIMENTS

Hereinafter, embodiments of the present invention will be described based on the drawings. Note that the elements common in the respective drawings are assigned with the same reference signs and redundant explanation will be omitted. Further, the present invention is not limited by the following embodiments.

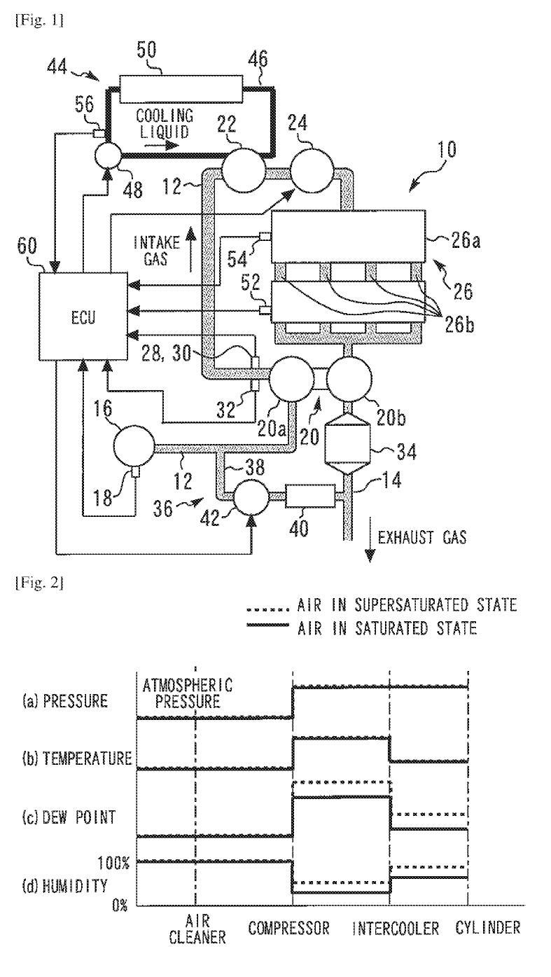

### Embodiment 1

[Explanation of system configuration] First, Embodiment 1 of the present invention will be described with reference to FIG. 1 to FIG. 3.

FIG. 1 is a diagram for explaining a configuration of a control system for an internal combustion engine of Embodiment 1 of the present invention. As shown in FIG. 1, the control system of the present embodiment includes an internal combustion engine 10. The internal combustion engine 10 is configured as an in-line four-cylinder engine to be loaded on a movable body such as a vehicle. However, the number of cylinders and cylinder arrangement of the internal combustion engine 10 are not limited to this. An intake passage 12 and an exhaust passage 14 communicate with respective cylinders of the internal combustion engine 10.

An air cleaner 16 is mounted in a vicinity of an inlet of the intake passage 12. The air cleaner 16 is provided with an air flow meter 18 that outputs a signal corresponding to a flow rate of fresh air which is taken into the intake passage 12. A compressor 20a of a turbocharger 20 is installed downstream of the air cleaner 16. The compressor 20a is driven by rotation of a turbine 20b that is disposed in the exhaust passage 14. A water-cooling type intercooler 22 is provided in the intake passage 12 at a downstream side from the compressor 20a.

An electronically-controlled throttle valve 24 is provided in the intake passage 12 at a downstream side from the intercooler 22. The intake passage 12 at a downstream side from the throttle valve 24 is configured as an intake manifold 26 that is connected to intake ports (not illustrated) of the respective cylinders. The intake manifold 26 includes a collection part 26a that functions as a surge tank, and intake branch piping 26b that connects the collection part 26a and the respective intake ports.

In the intake passage 12 between the compressor 20a and the intercooler 22, a temperature sensor 28, a pressure sensor 30 and a humidity sensor 32 are provided. The temperature sensor 28, the pressure sensor 30 and the humidity sensor 32 are sensors that output signals corresponding to a temperature, pressure and humidity of gas that flows in the intake passage 12 between the compressor 20a and the intercooler 22.

Here, the humidity sensor 32 is not provided in the intake passage 12 at the intercooler 22 side, but is provided in the intake passage 12 at the compressor 20a side. The humidity sensor 32 is more desirably provided in the intake passage 12 directly downstream of the compressor 20a. A temperature of gas compressed by the compressor 20a (hereinafter, called “compressed gas”) is the highest directly downstream of the compressor 20a, and becomes lower toward the intercooler 22 side. Therefore, in order to grasp a behavior of the humidity of the compressed gas (details will be described later) accurately, the humidity sensor 32 is desirably provided in a position like this. Further, a distance from a gas exhaust port of the compressor 20a to an installation spot of the humidity sensor 32 is desirably equal to a distance from the gas exhaust port to an installation spot of the temperature sensor 28 and equal to a distance to an installation spot of the pressure sensor 30 from the gas exhaust port at the same time.

In the exhaust passage 14 at a downstream side from the turbine 20b, a catalyst (a three-way catalyst as one example) 34 for purifying exhaust gas is included.

Further, the control system of the present embodiment includes a low pressure EGR device 36. The low pressure EGR device 36 includes an EGR passage 38 that connects the exhaust passage 14 at a downstream side from the catalyst 34, and the intake passage 12 at an upstream side from the compressor 20a. An EGR cooler 40 and an EGR valve 42 are provided halfway through the EGR passage 38 in sequence from an upstream side of a flow of EGR gas at a time of the FOR gas being recirculated to the intake passage 12. The EGR cooler 40 is included to cool the EGR gas flowing in the EGR passage 38, and the EGR valve 42 is included to regulate a flow rate of the EGR gas.

Further, the control system of the present embodiment includes a cooling liquid circulation device 44. The cooling liquid circulation device 44 includes a cooling liquid circulation path 46 for circulating a cooling liquid, an electric-powered water pump 48 for circulating the cooling liquid into the cooling liquid circulation path 46, and a radiator 50. A core (not illustrated) of the intercooler 22 is connected to the cooling liquid circulation path 46. The water pump 48 is driven to circulate the cooling liquid into the cooling liquid circulation device 44, whereby heat conversion is performed between the cooling liquid flowing through the core of the intercooler 22 and the compressed gas, and the compressed gas is cooled.

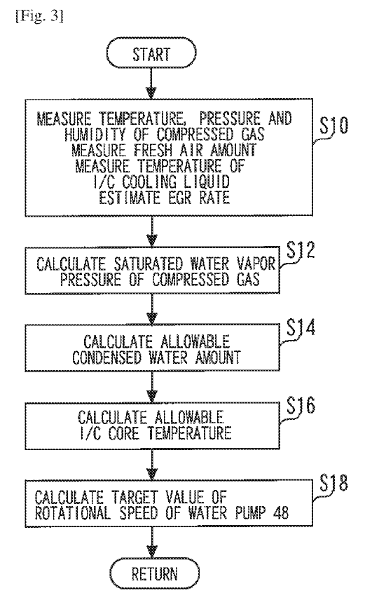

The control system of the present embodiment further includes an ECU (Electronic Control Unit) 60. The ECU 60 includes at least an input/output interface, a memory and a CPU. The input/output interface is provided to take in sensor signals from various sensors mounted to the internal combustion engine 10 and the movable, body, and to output operation signals to actuators included by the internal combustion engine 10. The sensors from which the ECU 60 takes in the signals include a crank angle sensor 52 for measuring an engine speed, a pressure sensor 54 for measuring pressure in the collection part 26a, a water temperature sensor 56 for measuring a temperature of the cooling liquid in the cooling liquid circulation device 44 and the like, besides the air flow meter 18, the temperature sensor 28, the pressure sensor 30 and the humidity sensor 32 which are described above. The actuators to which the ECU 60 outputs the operation signals include a fuel injection valve for injecting fuel into the cylinders or the intake port of the internal combustion engine 10 and the like, besides the throttle valve 24, the EGR valve 42 and the water pump 48 which are described above. In the memory, various control programs for controlling the internal combustion engine 10, maps and the like are stored. The CPU reads the control programs and the like from the memory and executes the control programs and the like, and generates operation signals based on the sensor signals which are taken in.

[Feature of Embodiment 1] FIG. 2 is a diagram showing behaviors of pressures, temperatures, dew point temperatures and relative humidities of two kinds of air flowing in the intake passage during a supercharging operation of the internal combustion engine. The two kinds of air differ in the water content, and more specifically are air with a relative humidity of approximately 100% (air in a saturated state: solid lines) and air with a relative humidity of substantially 100% containing mist (air in a supersaturated state: broken lines). Conditions other than the water content (conditions of the pressures, temperatures, dew point temperatures and relative humidities of the two kinds of air before introduced into the intake passage, the operation conditions of the internal combustion engine that introduces the two kinds of air, the drive conditions of the water pump of the cooling liquid circulation device and the like) are the same.

As shown in FIG. 2, the pressures and the temperatures of the two kinds of air rise in the intake passage at a downstream side from the compressor ((a) and (b) in FIG. 2). Further, in the intake passage at the downstream side, the dew points of the two kinds of air also rise ((c) in FIG. 2). However, these dew points show different behaviors. That is to say, the dew point of the air in the supersaturated state is higher than the dew point of the air in the saturated state. Similarly to the dew points, the humidity of the air in the supersaturated state is higher than the humidity of the air in the saturated state ((d) in FIG. 2).

The dew points and the humidities of the two kinds of air show different behaviors for tile following reason. That is to say, when the air is compressed with the compressor, the partial pressure of the water vapor contained in the compressed air rises, and the temperature of the compressed air also rise, whereby the saturated water vapor pressure rises. Here, the relative humidity is expressed as the partial pressure of the water vapor relative to the saturated water vapor pressure, and therefore if the partial pressure of the water vapor contained in the air after passing through the compressor is equal to or higher than the saturated water vapor pressure, the relative humidity remains to be approximately 100%. However, if the partial pressure of the water vapor is not equal to or higher than the saturated water vapor pressure, mist around the air in the supersaturated state can be evaporated. The broken lines in (c) and (d) in FIG. 2 show the behaviors of the dew point and the humidity of the air in the supersaturated state in the case like this. Therefore, in (c) and (d) of FIG. 2, both the dew point and the humidity of the air in the supersaturated state are higher than the dew point and the humidity of the air in the saturated state.

The difference in dew point and the difference in humidity between the two kinds of air which occur after passing through the compressor similarly occur at a time of passing through the intercooler. Therefore, when cooling conditions in the intercooler are fixed without giving consideration to the differences like this, a lot of condensed water is likely to be generated when the gas in the supersaturated state passes. In that case, there arises the fear of causing corrosion of the intercooler due to the generated condensed water, and occurrence of misfire in the internal combustion engine 10. Therefore, in the present embodiment, control of regulating the rotational speed of the water pump 48 (hereinafter, called “I/C temperature regulation control”) is performed with use of output signals from the temperature sensor 28, the pressure sensor 30 and the humidity sensor 32.

As described above, the temperature sensor 28, the pressure sensor 30 and the humidity sensor 32 are provided in the intake passage 12 between the compressor 20a and the intercooler 22. Therefore, the behaviors of the temperature, the pressure and the humidity of the compressed gas flowing in the intake passage 12 at the upstream side from the intercooler 22 can be accurately grasped. Therefore, at a time of execution of the I/C temperature regulation control, the amount of the condensed water which is generated in the intercooler 22 can be restrained to be equal to or smaller than an allowable amount,

FIG. 3 is a flowchart showing a routine of the I/C temperature regulation control executed by the ECU 60. Note that the present routine is started at a time of start of rotation of the turbine 20b, and is repeatedly executed at each predetermined control period.

In the routine shown in FIG. 3, the temperature, the pressure and the humidity of the compressed gas, the amount of fresh air taken into the intake passage 12, a temperature of the cooling liquid (hereinafter, called “the I/C cooling liquid”) in the cooling liquid circulation device 44 are measured first, and an EGR rate is estimated (step S10). More specifically, in the present step, the temperature, the pressure and the humidity of the compressed gas are measured based on the output signals from the temperature sensor 28, the pressure sensor 30 and the humidity sensor 32. Further, the amount of fresh air is measured based on the output signal from the air flow meter 18. Further, the temperature of the I/C cooling liquid is measured based on the output signal from the water temperature sensor 56. Further, the EGR rate is estimated based on the measured amount of fresh air, and information concerning an opening degree of the EGR valve 42 (for example, an output signal from an opening degree sensor installed in a vicinity of the EGR valve 42, or the like).

Subsequently, the saturated water vapor pressure of the compressed gas is calculated (step S12). More specifically, in the present step, the saturated water vapor pressure of the compressed gas is calculated based on the temperature and the pressure of the compressed gas measured in step S10, and a map stored in the ECU 60 in advance. Note that the saturated water vapor pressure of the compressed gas also can he calculated by inputting the temperature and the pressure of the compressed gas measured in step S10, into a model calculation formula setting a relation of the temperature and the pressure of the gas flowing in the intake passage of the supercharging engine, and the saturated water vapor pressure of the gas.

Subsequently, the allowable value (hereinafter, called “an allowable condensed water amount”) of the amount of the condensed water generated in the intercooler 22 is calculated based on the operation conditions of the internal combustion engine 10 (step S14). More specifically, in the present step, the allowable condensed water amount is calculated based on output signals from the crank angle sensor 52 and the pressure sensor 54, and the map stored in the ECU 60 in advance.

Subsequently, an allowable value (hereinafter, called “an allowable I/C core temperature”) of a temperature of the core of the intercooler 22 is calculated (step S16). More specifically, in the present step, the allowable I/C core temperature is calculated based on the humidity of the compressed gas measured in step S10, the EGR rate estimated in step S10, the saturated water vapor pressure of the compressed gas calculated in step S12, the allowable condensed water amount calculated in step S14, and the map stored in the ECU 60 in advance.

Subsequently, a target value of the rotational speed of the water pump 48 is calculated (step S18). More specifically, in the present step, a target value of the rotational speed of the water pump 48 is calculated, based on the temperature of the I/C cooling liquid measured in step S10, the allowable I/C core temperature calculated in step S16, and the map stored in the ECU 60 in advance. The calculated target value is inputted to the water pump 48 from the ECU 60, and thereby the rotational speed of the water pump 48 is regulated to increase or decrease.

As above, according to the processing of the routine shown in FIG. 3, the amount of the condensed water that is generated in the intercooler 22 can be reduced to be equal to or smaller than the allowable condensed water amount. Accordingly, in the case of the gas in the supersaturated state being compressed by the compressor 20a, the amount of the condensed water generated in the intercooler 22 can be reduced to be equal to or smaller than the allowable condensed water amount.

Incidentally, in Embodiment 1 described above, explanation is made with the control system including the low pressure EGR device 36 as an example. However, the present invention can be also applied to a control system that does not include the low pressure EGR device 36. When the present invention is applied to a control system of a non-EGR system like this, the processes of step S12 and the following steps can be performed with the EGR rate in step S10 in FIG. 3 is assumed to be zero.

Further, in Embodiment 1 described above, at the dine of I/C temperature regulation control which is executed by the ECU 60, the temperature of the compressed gas is measured by using the output signal from the temperature sensor 28, and the pressure of the compressed gas is measured by using the output signal from the pressure sensor 30. However, the temperature and the pressure of the compressed gas may be obtained by estimation. More specifically, the pressure of the compressed gas may be estimated based on an opening degree of a bypass valve (for example, a wastegate valve) that is generally provided in a bypass passage of the turbine 20b. Further, the temperature of the compressed gas may be estimated based on the temperature of the cooling liquid for the internal combustion engine 10. The temperature of the compressed gas may be estimated based on the output signal from a temperature sensor that is provided at a spot different from the intake passage 12 between the compressor 20a and the intercooler 22. Note that the present modification can be applied similarly in embodiments 2 and 3 that will be described later.

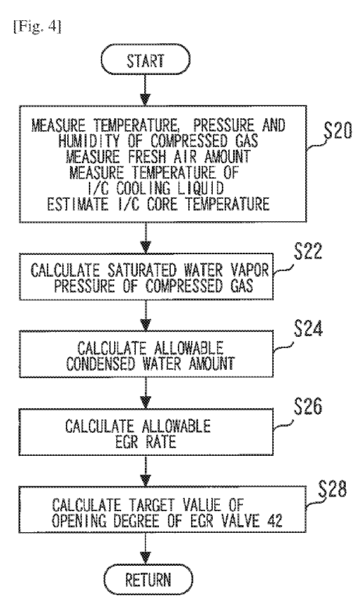

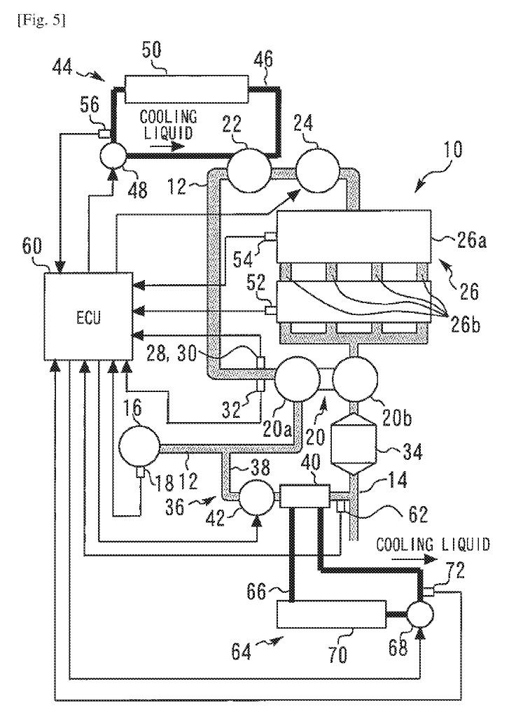

### Embodiment 2

[Feature of Embodiment 2] Next, Embodiment 2 of the present invention will be described with reference to FIG. 4.

The present embodiment has a feature of executing a routine shown in FIG. 4 in the ECU 60 with a system configuration similar to Embodiment 1 described above as a precondition. Hereinafter, explanation of the feature part will be made, and explanation of the common part to Embodiment 1 described above will be omitted or simplified.

In Embodiment 1 described above, the UC temperature regulation control is executed for the purpose of restraining the amount of the condensed water that is generated in the intercooler 22 to be equal to or smaller than the allowable amount. An object of control which is executed in the present embodiment is similar. However, in the present embodiment, control (hereinafter, called “EGR rate control”) which regulates an opening degree of the EGR valve 42 to increase or decrease instead of the rotational speed of the water pump 48 is executed, with the rotational speed of the water pump 48 during drive of the compressor 20a fixed.

When the rotational speed of the water pump 48 is fixed, the amount of the condensed water generated in the intercooler 22 is significantly influenced by a temperature difference between the temperature of the core (hereinafter, called an “UC core temperature”) of the intercooler 22 and the temperature of the compressed gas. Since the temperature of the compressed gas has correlation with the EGR rate, if the EGR rate control is executed, the temperature difference is made small, and the amount of the condensed water generated in the intercooler 22 can be restrained to be equal to or smaller than the allowable amount,

FIG. 4 is a flowchart showing a routine of the EGR rate control executed by the ECU 60. Note that the routine is assumed to be started at a time of start of rotation of the turbine 20b, and to be repeatedly executed at each predetermined control period.

In the routine shown in FIG. 4, the temperature, the pressure and the humidity of the compressed gas, the fresh air amount which is taken into the intake passage 12, and the temperature of the I/C cooling liquid are measured, and the IC core temperature is estimated (step S20). The process of the present step is basically the same as the process of step S10 in FIG. 3. The process in step S10 in FIG. 3 differs from the process of the present step in that the EGR rate is estimated in the process in step S10 in FIG. 3, whereas in the process of the present step, the IC core temperature is estimated. In the present step, the IC core temperature is estimated based on the temperature of the I/C cooling liquid which is measured, and the rotational speed of the water pump 48.

Subsequently, the saturated water vapor pressure and the allowable condensed water amount of the compressed gas are calculated (steps S22 and S24). These processes are the same as the processes in steps S12 and 514 in FIG. 3.

Subsequently, an allowable value of the EGR rate (hereinafter, called “an allowable EGR rate”) is calculated (step S26). More specifically, in the present step, the allowable EGR rate is calculated based on the humidity of the compressed gas measured in step S20, the I/C core temperature estimated in step S20, the saturated water vapor pressure of the compressed gas calculated in step S22, the allowable condensed water amount calculated in step S24, and a map stored in the ECU 60 in advance.

Subsequently, a target value of an opening degree of the EGR valve 42 is calculated (step S28). More specifically, in the present step, the target value of the opening degree of the EGR valve 42 is calculated based on the fresh air amount measured in step S20, and the allowable EGR rate calculated in step S26. The calculated target value is inputted to the EGR valve 42 from the ECU 60, and thereby, the opening degree of the EGR valve 42 is regulated to be increased or decreased.

As above, according to the processing of the routine shown in FIG. 4, an effect similar to the effect of Embodiment 1 described above can be obtained.

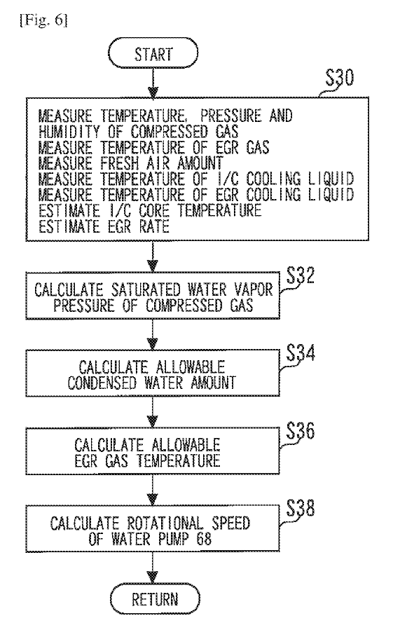

### Embodiment 3

[Explanation of system configuration] Next, Embodiment 3 of the present invention will be described with reference to FIG. 5 and FIG. 6. Note that in the present embodiment, it is the precondition that the EGR cooler 40 is of a water-cooling type.

FIG. 5 is a diagram for explaining a configuration of a control system for an internal combustion engine of Embodiment 3 of the present invention. As shown in FIG. 5, the control system of the present embodiment includes a temperature sensor 62 which is provided in the EGR passage 38 at an upstream side (that is, the exhaust passage 14 side from the EGR cooler 40) from the EGR cooler 40. The temperature sensor 62 is a sensor that outputs a signal corresponding to a temperature of the EGR gas before passing through the EGR cooler 40.

Further, the control system of the present embodiment includes a cooling liquid circulation device 64. The cooling liquid circulation device 64 includes a cooling liquid circulation path 66 for circulating the cooling liquid, an electric-powered water pump 68 for circulating the cooling liquid into the cooling liquid circulation path 66, and a radiator 70. An internal channel (not illustrated) of the EGR cooler 40 is connected to the cooling liquid circulation path 66. The water pump 68 is driven to circulate the cooling liquid into the cooling liquid circulation device 64, whereby heat exchange, is performed between the cooling liquid which flows in the internal channel of the EGR cooler 40, and the EGR gas, and the EGR gas is cooled.

A water temperature sensor 72 for measuring the temperature of the cooling liquid in the cooling liquid circulation device 64 is connected to an input side of the ECU 60, besides the temperature sensor 62. The water pump 68 is connected to an output side of the ECU 60.

[Feature of Embodiment 3] In Embodiment 1 described above, the I/C temperature regulation control is executed for the purpose of restraining the amount of the condensed water generated in the intercooler 22 to he equal to or smaller than the allowable amount. An object of the control executed in the present embodiment is the same. However, in the present embodiment, control of regulating a rotational speed of the water pump 68 to increase or decrease the rotational speed (hereinafter, called “EGR gas temperature control”) is executed while the compressor 20a is driven. Note that in the present embodiment, the rotational speed of the water pump 48 is assumed to be fixed as in Embodiment 2 described above.

As described in Embodiment 2 described above, when the rotational speed of the water pump 48 is fixed, the amount of the condensed water generated in the intercooler 22 is significantly influenced by the temperature difference between the I/C core temperature and the temperature of the compressed gas. Since the temperature of the compressed gas has a correlation with the EGR gas temperature, if the EGR gas temperature control is executed, the temperature difference is made small, and the amount of the condensed water generated in the intercooler 22 can be restrained to be equal to or smaller than the allowable amount.

FIG. 6 is a flowchart showing a routine of the EGR gas temperature control executed by the ECU 60. Note that the present routine is assumed to be started at the time of start of rotation of the turbine 20b and to be repeatedly executed at each predetermined control period.

In the routine shown in FIG. 6, the temperature, the pressure and the humidity of the compressed gas, the temperature of the EGR gas, the amount of fresh air which is taken into the intake passage 12, the temperature of the I/C cooling liquid, and the temperature of a cooling liquid in the cooling liquid circulation device 64 (hereinafter, called “an EGR cooling liquid”) are measured first, and the EGR rate and the I/C core temperature are estimated (step S30). More specifically, in the present step, the temperature, the pressure and the humidity of the compressed gas are measured based on the output signals from the temperature sensor 28, the pressure sensor 30 and the humidity sensor 32. Further, the temperature of the EGR gas is measured based on the output signal from the temperature sensor 62. Further, the fresh air amount is measured based on the output signal from the air flow meter 18. Further, the temperature of the I/C cooling liquid is measured based on the output signal from the water temperature sensor 56. Further, the temperature of the EGR cooling liquid is measured based on the output signal from the water temperature sensor 72. Further, the EGR rate is estimated based on the measured fresh air amount, and information concerning the opening degree of the EGR valve 42 (for example, an output signal from an opening degree sensor installed in a vicinity of the EGR valve 42, or the like). Further, the IC core temperature is estimated based on the measured temperature of the I/C cooling liquid, and the rotational speed of the water pump 48.

Subsequently, the saturated water vapor pressure and the allowable condensed water amount of the compressed gas are calculated (steps S32 and S34). Processes in these steps are the same as the processes in steps S12 and S14 in FIG. 3.

Subsequently, the allowable value of the EGR gas temperature (the allowable EGR gas temperature) is calculated (step S36). More specifically, in the present step, the allowable EGR gas temperature is calculated based on the humidity of the compressed gas measured in step S30, the EGR rate and the I/C core temperature estimated in step S30, the saturated water vapor pressure of the compressed gas calculated in step S32, the allowable condensed water amount calculated in step S34, and the map stored in the ECU 60 in advance.

Subsequently, a target value of a rotational speed of the water pump 68 is calculated (step S38). More specifically, in the present step, the target value of the rotational speed of the water pump 68 is calculated based the temperatures of the EGR gas and the EGR cooling liquid measured in step S30, the allowable EGR gas temperature calculated in step S36, and the map stored in the ECU 60 in advance. The calculated target value is inputted to the water pump 68 from the ECU 60, and thereby the rotational speed of the water pump 68 is regulated to be increased or decreased.

As above, according to the processing of the routine shown in FIG. 6, an effect similar to the effect of Embodiment 1 described above can be obtained.

Incidentally, in Embodiment 3 described above, the temperature of the EGR gas is measured based on the output signal from the temperature sensor 62. However, the position of the temperature sensor 62 may be in the exhaust passage 14 at the downstream side of the catalyst 34. The temperature of the FOR gas may be obtained by a known estimation method.

### REFERENCE SIGNS LIST

10 internal combustion engine

12 intake passage

14 exhaust passage

18 air flow meter

20 turbocharger

20a compressor

20b turbine

22 intercooler

28,62 temperature sensor

30,54 pressure sensor

56,72 water temperature sensor

32 humidity sensor

36 low pressure EGR device

60 ECU

1. A control system for an internal combustion engine comprising a compressor that is configured to compress intake gas flowing in an intake passage of an internal combustion engine, an intercooler that is configured to cool the intake gas compressed by the compressor, and a humidity sensor that is configured to measure a humidity of the intake gas flowing in the intake passage, and being configured to execute control concerning a water content in the intake gas passing through the intercooler at a time of driving the compressor, based on an output signal from the humidity sensor,
wherein the humidity sensor is provided in the intake passage between the compressor and the intercooler.

2. The control system according to claim 1,
wherein the humidity sensor is provided directly downstream of the compressor.

3. The control system according to claim 1,
wherein the control is control an amount of condensed water generated in the intercooler is restrained equal to or smaller than an allowable amount.

4. The control system according to claim 1, further comprising:
an EGR device that is configured to recirculate a part of exhaust gas flowing in an exhaust passage at a downstream side from a turbine connected to the compressor to the intake passage at an upstream side from the compressor.
